(19) United States
(12) Patent Application Publication
(10) Pub. No.: US 2012/0071387 A1
(43) Pub. Date: Mar. 22, 2012

(54) Soap Saver

(76) Inventor: Harold Walter AESCH, JR., Chandler, AZ (US)

(21) Appl. No.: 13/316,091

(22) Filed: Dec. 9, 2011

Related U.S. Application Data
(60) Provisional application No. 61/549,455, filed on Oct. 20, 2011.

(51) Int. Cl. C11D 17/00

(52) U.S. Cl. 510/449

(57) ABSTRACT

A soap saver comprises an original soap bar and a soap fragment. The original soap bar comprises a cavity. The cavity comprises a predetermined shape, a cavity wall, and a cavity bottom surface. The cavity wall will be a continuous wall and will be connected to the cavity bottom surface. The cavity wall will have a smooth surface around the wall. The cavity bottom surface will not be a smooth surface. The soap fragment will be inserted into the cavity so the soap fragment can be reused with the original soap bar. Water will combined both the soap fragment and the original soap bar together.

The current application claims a priority to the U.S. Provisional Patent application Ser. No. 61/549,455 filed on Oct. 20, 2011.

### FIELD OF THE INVENTION

The present invention relates generally to an apparatus for soap. More specifically, the apparatus is a bar of soap that allows a user to save the remains of another bar of soap.

### BACKGROUND OF THE INVENTION

Currently there are many different types of soap available in the market. However after using the soap for a while when it comes to a point that only a small piece of soap is left over it becomes very difficult to use the soap. Eventually the leftover soap ends up in a landfill creating pollutant object. Most of the soap fragments that go into landfill are biodegradable but the quantity is in the millions of lbs per year. Even though the soap fragments are biodegradable, they will take some time to complete the whole biodegradable process. It is therefore an object of the present invention to recycle the soap fragment that is left over. The process of the present invention is simple and elegant. It is a further object of the present invention to create an oval-shaped cavity in an original new bar of soap that allows for a 99% used bar of soap to be inserted and incorporated into the new bar of soap.

### BRIEF DESCRIPTION OF THE DRAWINGS

FIG. 1 is an illustration of a prior art of a traditional bar of soap and a soap fragment.

FIG. 2 is a bottom exploded perspective view of the present invention showing a recess in the bottom of a bar of soap and a soap fragment to be combined on the bottom surface of the bar of soap.

FIG. 3 is a bottom perspective view of the present invention with the soap fragment sitting in the recess on the bottom of the bar of soap.

FIG. 4 is an exploded cross sectional view of the present invention showing the soap scrap coming out of the recess on the bottom side of the bar of soap.

FIG. 5 is a cross sectional view of the present invention showing the soap scrap sitting in the recess on the bottom side of the bar of soap.

FIG. 6 is view of the system for the soap saver.

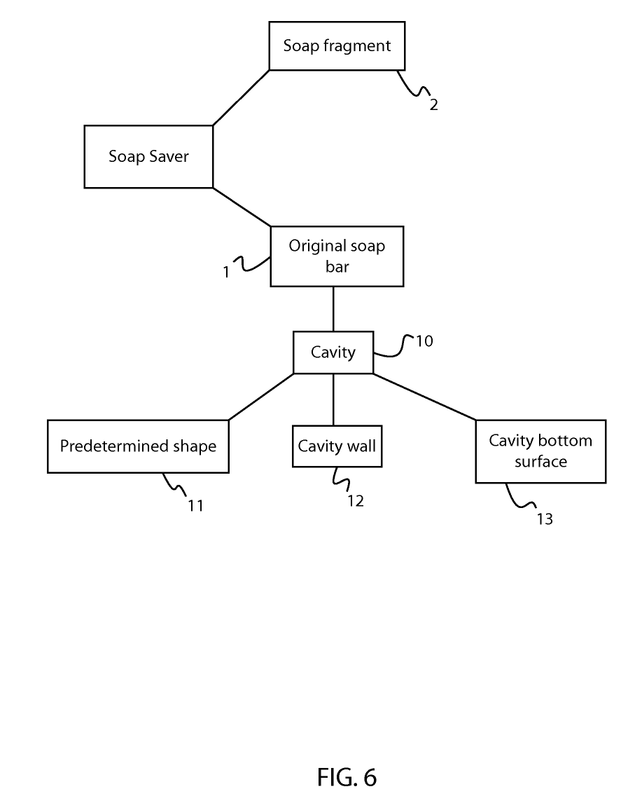

### DETAIL DESCRIPTIONS OF THE INVENTION

All illustrations of the drawings are for the purpose of describing selected versions of the present invention and are not intended to limit the scope of the present invention.

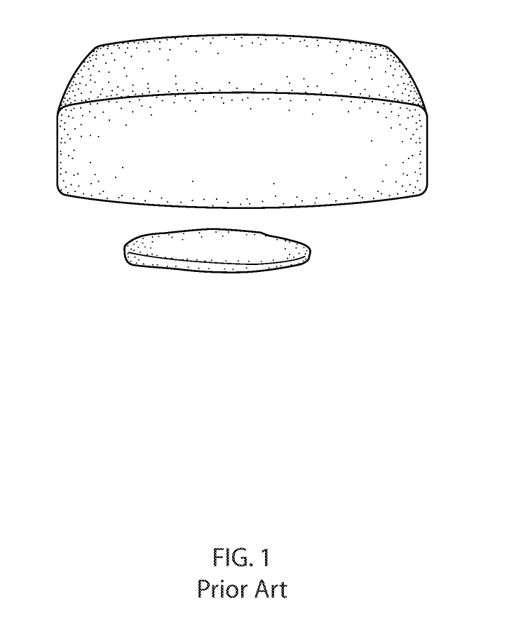

The traditional soap bars have many different geometric shapes and they are available in many different sizes. Oval and rectangular shapes are the most common shapes in the current market. In references to FIG. 1, the traditional soap bar will become a small soap piece after multiple uses. The small soap piece or pieces will not be useful even though it carries the same cleaning properties just like the new traditional soap bar. The small soap piece or pieces will be hard handle and will break apart easily. Consumers will not use the small soap piece or pieces because of those difficulties and the small soap piece or pieces will be a waste.

The present invention is shown and described herein as an apparatus for recycling the small soap piece or pieces that are left over from previous use. In the preferred embodiment, the present invention comprises a cavity 10. The cavity 10 comprises a predetermined shape 11, a cavity wall 12, and a cavity bottom surface 13. The cavity 10 is positioned in an original soap bar 1. The cavity 10 allows for a soap fragment 2 to be inserted and incorporated into the original soap bar 1.

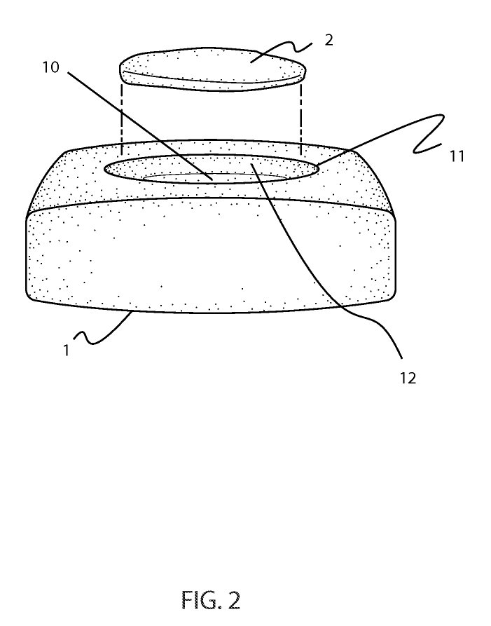

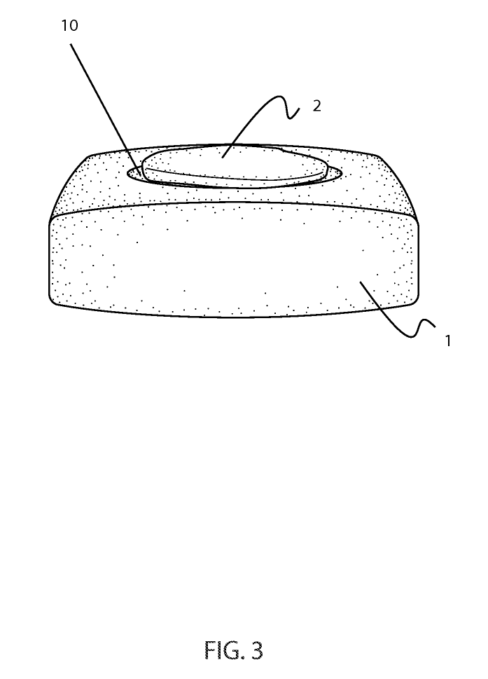

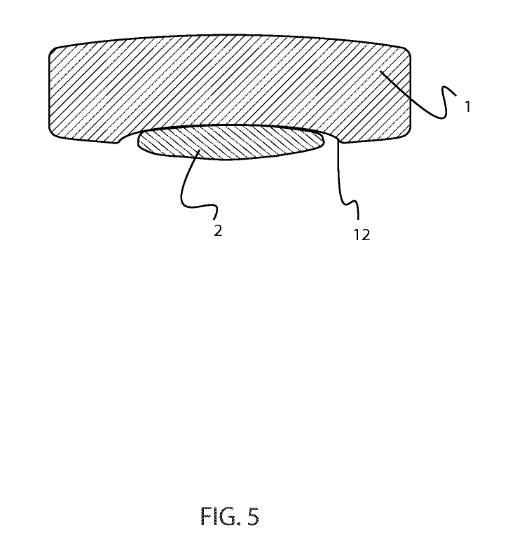

The cavity 10 can be placed within any sides of the original soap bar 1. In reference to FIG. 2 and FIG. 3, the soap fragment 2 will be positioned inside the cavity 10 of the original soap bar 1. The cavity 10 will not be open from any of the sides other than the top side of the cavity 10. All of the other side except the cavity 10 side in the original soap bar 1 will have the same surface and the same structural design so the consumers will be able to tell the difference between the cavity 10 and normal surface with a quick glance at the original soap bar 1. In reference to FIG. 5, when either bar of soap becomes wet, both original soap bar 1 and the soap fragment 2 will be adhesive to each other over time. The adhesive process can also be manually done by the consumers with a compress force provided into both the original soap bar 1 and the soap fragment 2. Now the consumers can used the both original soap bar 1 and soap fragment 2 together as a one single unit.

The preference of the soap selection is different from one consumer to another consumer but each individual customer will normally stick with a certain kind or brand of soap. Therefore, the probability of them using the same kind or same brand of soap everyday will be considerably high. The geometric shape of the original soap bar 1 will determine the predetermined shape 11 of the cavity 10. The cavity 10 should mirror the original shape of the original soap bar 1. For an example, the Oval shape soap bar should have an oval shape cavity and the rectangular shape soap bar should have a rectangular shape cavity. Most of the soap fragment 2 will end up as the same original shape. As an example, a customer may have oval shape soap bar and will have an oval shape soap fragment after it has been used. The chances of that particular customer having the oval shape soap bar is more than possible so the oval soap fragment can be easily inserted into the new original soap bar 1 with minimum waste. There are many predetermined shapes 11 and the predetermined shapes 11 can be any of the different geometric shapes like oval, rectangular, square, triangle, circle, and many more. Different symbols can be designed within those different geometric symbols. For an example, the cavity 10 can be design as an apple symbol in the oval shape soap bar. That particular cavity 10 can be colored in red so the consumers will recognize the embedded symbol and at the same time, the cavity 10 will satisfy the oval geometric shape. The different design symbols can be a great marketing tool for kid's soap bars. It can easily be a cartoon character or famous kid's character during a given time period. Companies can easily create a certain design or a marketable character within the cavity 10 for adult soap bars, and keep the correct cavity specification, which will enhance the product sale and result more profits.

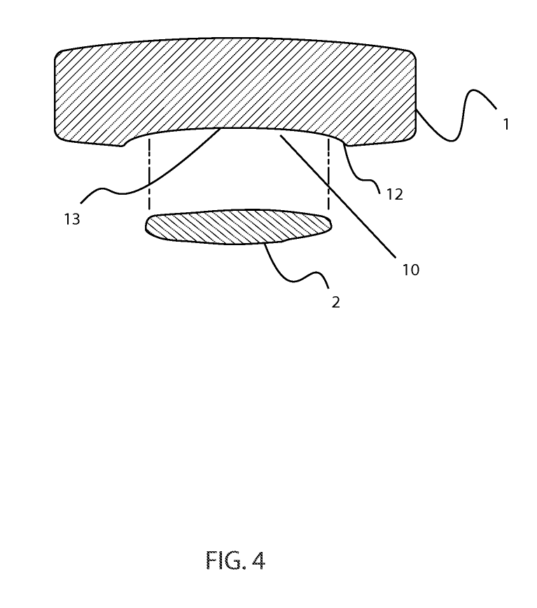

The cavity wall 12 will be one continuous surface which will be positioned around the cavity 10. As shown in FIG. 4, the cavity wall 12 will not be too deep into the original soap bar 1 and the cavity wall 12 will not have any kind of sharp edges or angles. All of the edges in the cavity wall 12 will have a smooth surface. The original soap bar 1 is designed under the above specification so the original soap bar 1 will be an efficient and a practical item. For an example, if the consumers do not have the soap fragment 2, the cavity will be empty while the original soap bar 1 being use by its consumers. If the cavity 10 is too deep and it has sharp edges or angles, the original soap bar 1 will break away into small pieces around the cavity 10 and this would make the original soap bar 1 inefficient. Since there is not enough material between the cavity walls 12, the cavity wall 12 will not be stable. As a solution for that problem, the cavity wall 12 will not be too deep and will not have any sharp edges or angles. The thickness of the cavity wall 12 will be higher than the depth of the cavity 10. Due to the smooth design of the cavity wall 12 the soap will stay as a one piece during the time it's been use and minimize its waste. Majority of the customers will have plastic soap containers for their soap bars. Over time the plastic soap containers will have some amount of soap stuck in its corners from the previous uses. Consumers can easily remove the wedged soap from the plastic containers and place them against the cavity wall 12 so absolutely zero amount of soap will be wasted. The cavity wall 12 will acts as a barrier so the consumers can easily place the soap simply by using their fingers.

The cavity bottom surface 13 will be the surface that is most visible to the consumers. The cavity bottom surface 13 will have a small curvature toward the inside of the original soap bar 1 and the middle of the cavity bottom surface 13 will be the deepest position compare to the surrounding cavity bottom surface 13. The cavity bottom surface 13 will not be a smooth surface. The cavity bottom surface 13 will be designed as a rough surface. As the first method to keep the cavity bottom surface 13 not smooth, the cavity bottom surface 13 will have a plurality of lines in different direction so the soap fragment 2 will easily stick to the original soap bar 1 and will not separate during over time. As for the second method to keep the cavity bottom surface 13 as a rough surface, Since most of the soap making companies stamps their trademark name into their products, companies can engraving their trademark name into the original soap bars 1 within the cavity bottom surface 13. At the same time, the cavity bottom surface 13 can be used for advertising purposes which will be an advantage in the product marketing strategies. Different short massages can be written on the cavity bottom surface 13. Because of the added characters or the short massages in the cavity bottom surface 13, the cavity bottom surface 13 will not be smooth surface.

The present invention can easily incorporate into the modern soap making machines and can easily be adapted to create the cavity 10 in the original soap bar 1. Companies will not have to do a lot of changes within their facilities because the existing soap making machines can be used and only the soap making dyes have to be interchanged during the process. This is a fairly inexpensive change into the modern soap making machines which will result in satisfied customers and successful product in a competitive market.

Although the invention has been explained in relation to its preferred embodiment, it is to be understood that many other possible modifications and variations can be made without departing from the spirit and scope of the invention as hereinafter claimed.

What is claimed is:

1. A Soap Saver comprises,
a original soap bar;
a soap fragment;
the original soap bar comprises a cavity.
the cavity being positioned on the original soap bar; and
the soap fragment being inserted into the cavity.

2. The Soap Saver as claimed in claim 1 comprises,
the cavity comprises a predetermined shape, a cavity wall, and a cavity bottom surface;
the predetermined shape comprises an oval shape, a rectangular shape, a square shape, a triangular shape, and a circular shape;
the cavity bottom surface being positioned at the bottom of the cavity;
the cavity wall being connected to the cavity bottom surface; and
the cavity wall being one continuous surface.

3. The Soap Saver as claimed in claim 2 comprises,
the cavity bottom surface being an rough surface; and
the cavity bottom surface being connected with the soap fragment.
